(19) United States
(12) Patent Application Publication
(10) Pub. No.: US 2020/0118287 A1
(43) Pub. Date: Apr. 16, 2020

(54) Method of Assembly Calibration for Multi-Camera system and Related Device

(71) Applicant: Augentix Inc., Hsinchu City (TW)

(72) Inventors: I-Chieh Hsieh, Hsinchu County (TW); Po-Yen Su, Taipei City (TW)

(21) Appl. No.: 16/162,365

(22) Filed: Oct. 16, 2018

(51) Int. Cl. G06T 7/70; H04N 19/139; G06K 9/32; G02B 27/00; H04N 5/232; G02B 27/09

(52) U.S. Cl. CPC G06T 7/70; H04N 19/139; G02B 27/0955; G02B 27/0037; H04N 5/23229; G06K 9/3233

(57) ABSTRACT

A method of assembly calibration for a multi-camera system is disclosed. The method comprises receiving at least two images respectively captured by at least two cameras in different angle of views, performing image transformation for aligning the received images which is optional, performing image motion estimation on an overlapping region of the images, for obtaining correspondence between the images with a plurality of motion vectors, wherein the plurality of motion vectors is used for indicating geometry relations between the images, performing dominant vector calculation according to the plurality of motion vectors, to obtain a dominant motion vector in region of interest (ROI) of the overlapping region, and calculating calibration parameters according to the obtained dominant motion vector, performing image correction according to the calibration parameters, to obtain a correct panoramic image covering the whole interested areas.

### BACKGROUND OF THE INVENTION

### 1. Field of the Invention

The present disclosure relates to a method used in a multi-camera system, and more particularly, to a method of assembly calibration for a multi-camera system.

### 2. Description of the Prior Art

Multi-camera system is more useful to acquire outdoor scenes or wide scenes than a single camera in a fixed view. In addition, combination of two or more cameras with normal lens, namely multi-camera system, can easily capture high-resolution images than the fisheye camera. However, multi-camera system requires assembly calibration for coordination, so as to obtain a panoramic image covering the whole interested areas.

There is an image correction method, which illustrates that multiple cameras capture images in different times/frames, to get the correction parameters at each time/frame, and then gradually calibrate the images according to the correction parameters. However, this conventional method requires multiple calibrations to achieve accurate multi-camera settings. Thus, it is necessary to propose an enhanced assembly calibration method to automatically calibrate the multi-camera settings at a time.

### SUMMARY OF THE INVENTION

It is therefore an objective to provide a method of assembly calibration for multi-camera system to solve the above problems.

The present disclosure provides a method of assembly calibration for a multi-camera system. The method comprises receiving at least two images respectively captured by at least two cameras in different angle of views, performing image transformation which is optional, performing image motion estimation on an overlapping region of the images, for obtaining correspondence between the images with a plurality of motion vectors, wherein the plurality of motion vectors are used for indicating geometry relations between the images, performing dominant vector calculation according to the plurality of motion vectors, to obtain a dominant motion vector in region of interest (ROI) of the overlapping region, and calculating calibration parameters according to the obtained dominant motion vector, performing image correction according to the calibration parameters, to obtain a correct panoramic image covering the whole interested areas.

The present disclosure provides an electronic device of a multi-camera system for multi-camera assembly calibration. The electronic device comprises an image receiving module, for receiving at least two images respectively captured by at least two cameras in different angle of views, an image transformation module which is optional, coupled to the image receiving module, for image alignment, a correspondence matching module, coupled to the image transformation module, for obtaining correspondence between the images with a plurality of motion vectors, wherein the plurality of motion vectors is used for indicating geometry relations between the images in an overlapping region, a dominant vector calculating module, coupled to the correspondence matching module, for obtaining a dominant motion vector in region of interest (ROI) of the overlapping region according to the plurality of motion vectors, a calibration module, coupled to the dominant vector calculating module, for calculating calibration parameters according to the obtained dominant motion vector, and an image correction module, coupled to the calibration module, for correcting a panoramic image according to the calibration parameters.

The present disclosure provides a multi-camera system for assembly calibration. The multi-camera system comprises at least two cameras, for capturing images in different angle of views, an electronic device, connecting to the at least two cameras, for performing an assembling calibration operation, wherein the electronic device includes a processing means for executing a program, and a storage unit coupled to the processing means for storing the program, wherein the program instructs the processing means to perform the following steps: receiving at least two images respectively captured by the at least two cameras in different angle of views, performing image transformation for aligning the images which is optional, performing image motion estimation on an overlapping region of the images, for obtaining correspondence between images with a plurality of motion vectors, wherein the plurality of motion vectors is used for indicating geometry relations between the images, performing dominant vector calculation according to the plurality of motion vectors, for obtaining a dominant motion vector in region of interest (ROI) of the overlapping region, calculating calibration parameters according to the obtained dominant motion vector, and performing image correction according to the calibration parameters, for obtaining a correct panoramic image.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a multi-camera system according to one embodiment of the present disclosure.

FIGS. 2-3 are schematic diagrams of an electronic device according to one embodiment of the present disclosure.

FIG. 4 is a flowchart according to an embodiment of the present disclosure.

FIGS. 5-7 are schematic diagrams of an assembly calibration operation according to embodiments of the present disclosure.

### DETAILED DESCRIPTION

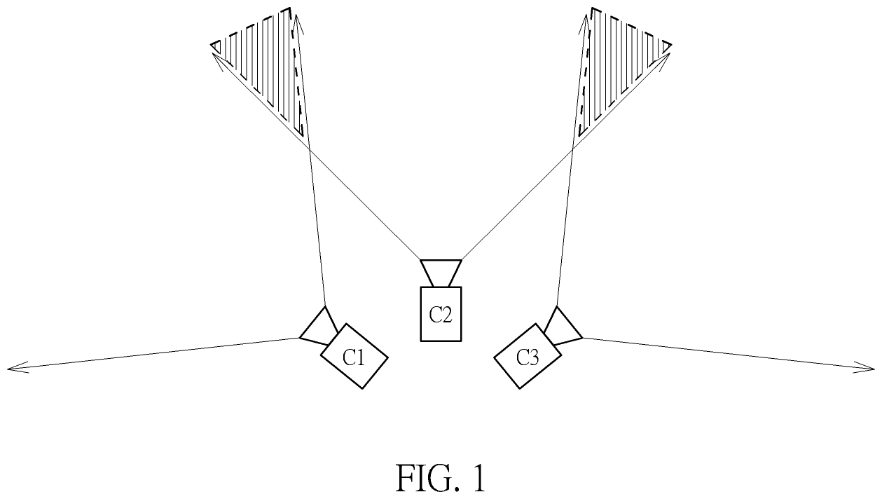

Please refer to FIG. 1, which is a schematic diagram of multi-camera system according to one embodiment of the present disclosure. The multi-camera system includes multiple cameras C1-C3 for capturing images for the interested area, where the number of cameras and the lens type (e.g. fisheye lens, wide-angle lens, ultra wide-angle lens or normal lens) of the cameras are not limited herein. The cameras C1-C3 may be arranged at different angle of views, but shall be coordinated to capture images in some overlap. Note that, the geometry relations between cameras C1-C3 of the multi-cameras system should be calibrated before usage, so as get images in correct field of view. In other words, the assembly calibration is able to improve the precision of multi-camera settings.

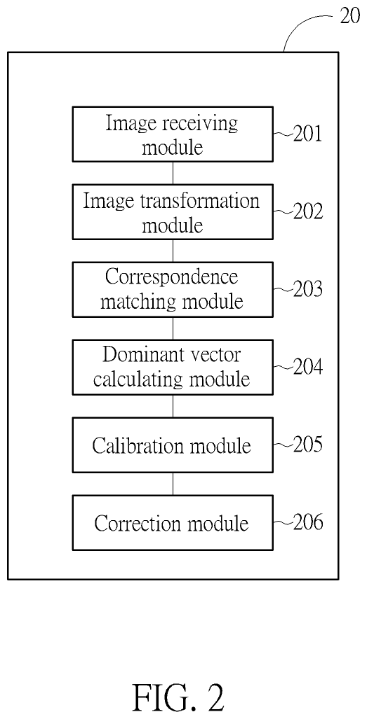

FIG. 2 is a schematic diagram of an electronic device according to one embodiment of the present disclosure. The electronic device 20 is utilized to implement an assembly calibration operation for the multi-camera system of FIG. 1, and includes an image receiving module 201, an image transformation module 202, a correspondence matching module 203, a dominant vector calculating module 204, a calibration module 205 and a correction module 206. In a word, the image receiving module 201 is used for receiving images from the cameras C1-C3. The image transformation module 202 is used for image alignment for the received images. The correspondence matching module 203 is used for obtaining correspondence between the received images in an overlapping region. The dominant vector calculating module 204 is used for obtaining a dominant motion vector in region of interest (ROI) of the overlapping region of the received images. The calibration module 205 is used for calculating the calibration parameters for multi-camera settings according to the dominant motion vector. The correction module 206 is used for correcting a panoramic image according to the calibration parameters.

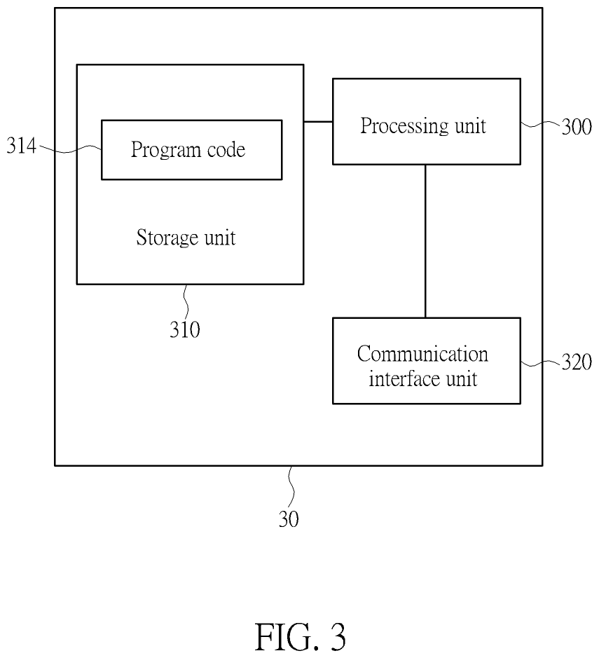

FIG. 3 is a schematic diagram of an electronic device according to one embodiment of the present disclosure. The electronic device 30 may include, not limited, a processing unit 300, such as a microprocessor or Application Specific Integrated Circuit (ASIC), a storage unit 310 and a communication interface unit 320. The storage unit 310 may be any data storage device that can store a program code 314, for access by the processing unit 300. Examples of the storage unit 310 include but are not limited to a subscriber identity module (SIM), read-only memory (ROM), flash memory, random-access memory (RAM), CD-ROMs, magnetic tape, hard disk, and optical data storage device. The communication interface unit 320 can be the image receiving module 201 of FIG. 2 and is applied with a wire or wireless communication for exchange signals/data with the cameras C1-C3 of FIG. 1.

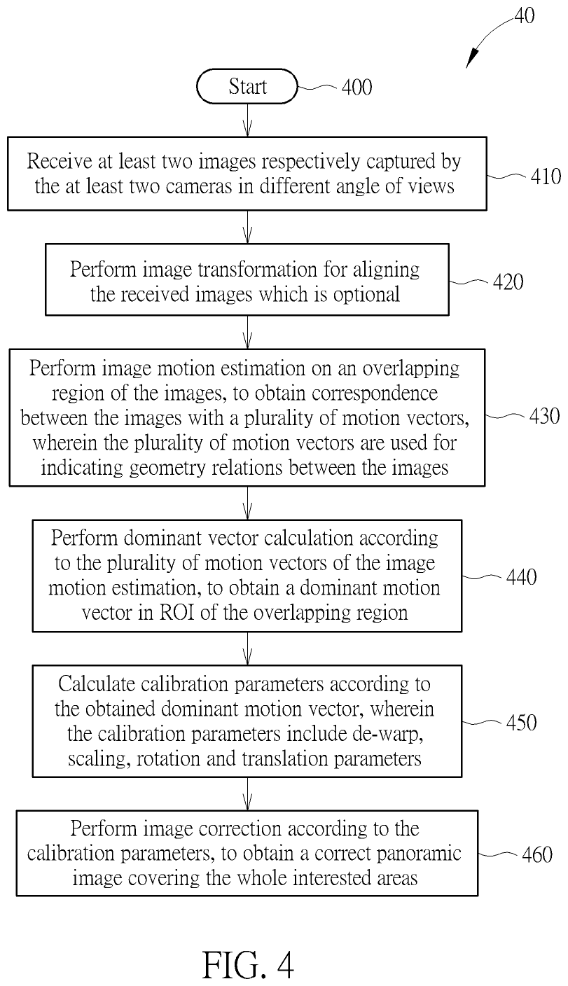

Please refer to FIG. 4, the assembly calibration operation of the electronic device 30 can be summarized as a process 40. The process 40 may be compiled into a program code 314 to be stored in the storage unit 310. As shown in FIG. 4, the process 40 include following steps:

Step 410: Receive at least two images respectively captured by the at least two cameras in different angle of views.

Step 420: Perform image transformation for aligning the received images which is optional.

Step 430: Perform image motion estimation on an overlapping region of the images, to obtain correspondence between the images with a plurality of motion vectors, wherein the plurality of motion vectors are used for indicating geometry relations between the images.

Step 440: Perform dominant vector calculation according to the plurality of motion vectors of the image motion estimation, to obtain a dominant motion vector in ROI of the overlapping region.

Step 450: Calculate calibration parameters according to the obtained dominant motion vector, wherein the calibration parameters include de-warp, scaling, rotation and translation parameters.

Step 460: Perform image correction according to the calibration parameters, to obtain a correct panoramic image covering the whole interested areas.

According to the process 40, the cameras C1-C3 of the multi-camera system perform image acquisition to obtain images with overlap, and then transmit the images to the electronic device 20, so as to get the calibration parameters for multi-camera assembly settings. On the other hand, the electronic device 20 performs image alignment for the received images which is optional, image motion estimation on the overlapping region of the two images (e.g. images from cameras Cl-C2, and images from cameras C2-C3), to obtain motion vectors (e.g. horizontal or vertical translations), and then performs dominant vector calculation according to the obtained motion vectors, for extracting the most dominant motion vector in ROI of the overlapping region, so as to increase the reliability of the correspondence between the images. Finally, the electronic device 20 calibrates one camera relative to another according to the calibration parameters calculated from the dominant motion vector, to realize assembly settings for the multi-camera system.

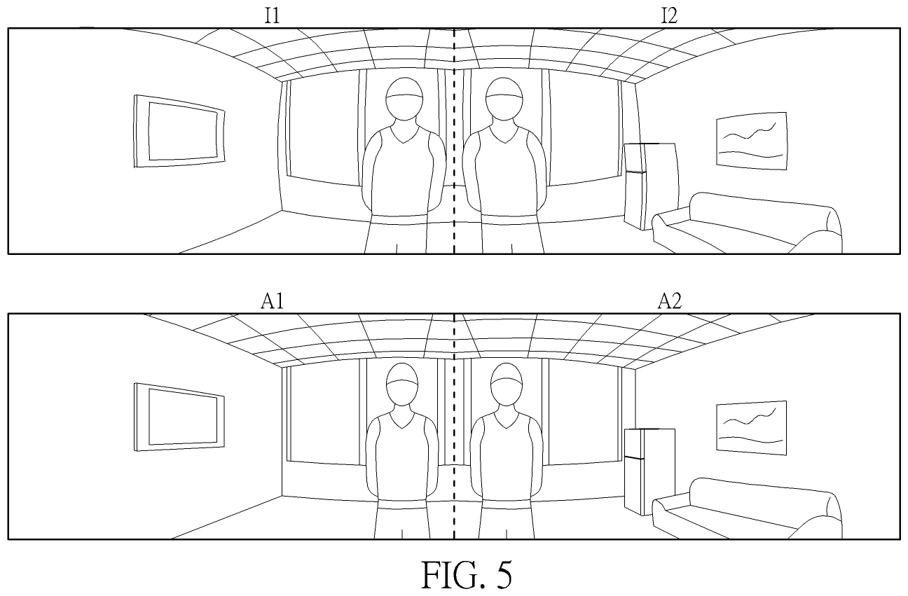

Reference is made to FIGS. 5-7, which illustrates detailed operation of the assembly calibration on the electronic device 20. In an embodiment, the electronic device 20 alternatively performs an image registration or an image transformation for aligning the received images. That is, the electronic device 20 may perform a lens distortion correlation, a de-warping or a geometry transformation on the received images. As shown in FIG. 5, the images I1 and I2 are de-warped for distortion correction, rotation correction, scaling correction and translation correction, so as to output aligned images A1 and A2. Note that, image transformation is an optional operation, depending on the camera lens and structure of the multi-camera set.

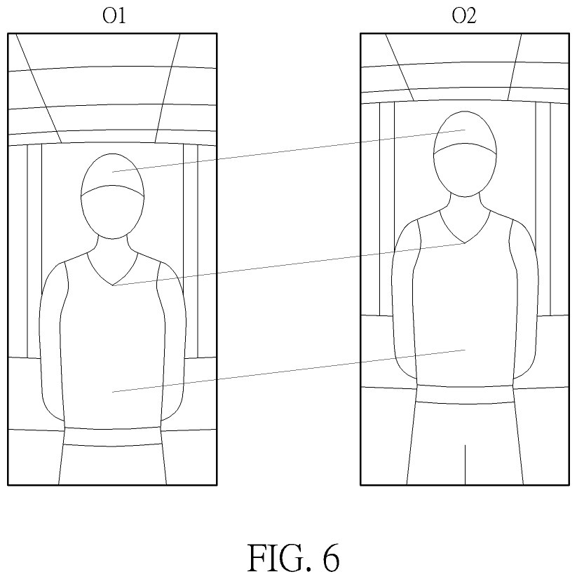

In addition, referring to FIG. 6, the overlapping regions O1 and O2 of the aligned images A1 and A2 are cropped for image motion estimation. The image motion estimation may be a content correspondence matching operation, an optical flow operation, a patch-based matching operation or a feature-based matching operation. In an embodiment, the image motion estimation is the optical flow operation. Note that, the optical flow operation is not applicable for a specific feature points of the images A1 and A2, but for all the pixels of the overlapping regions O1 and O2 of the images A1 and A2, to get optical flow vectors for every pixel of the overlapping regions O1 and O2 of the images A1 and A2, such that sufficient information (e.g. optical flow vectors) for calculating calibration parameters is obtained.

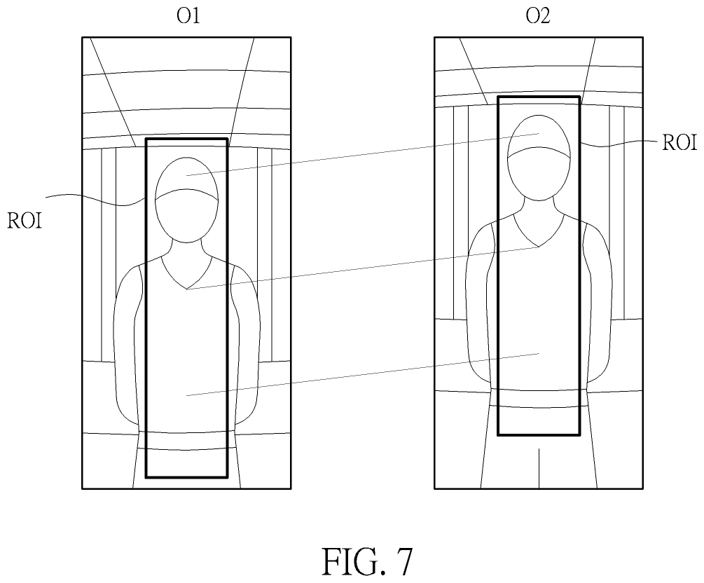

After obtaining the optical flow vectors, as shown in FIG. 7, the electronic device 20 performs the dominant vector calculation in ROI of the overlapping regions O1 and O2, to extract the most dominant flow vector from the obtained optical flow vectors. The dominant flow vector has the highest reliability for calculating calibration parameters for assembling settings such as de-warping, scaling, rotation and translation for the two cameras, but is not limited herein. For example, as shown in FIG. 7, the electronic device 20 gets calibration parameters indicating rotation 3° and offset 20 pixels for assembly difference. As can be seen, the automatic calibration between multiple cameras is realized by image content analysis without human intervention.

The abovementioned steps of the processes/operations including suggested steps can be realized by means that could be a hardware, a firmware known as a combination of a hardware device and computer instructions and data that reside as read-only software on the hardware device or an electronic system. Examples of hardware can include analog, digital and mixed circuits known as microcircuit, microchip, or silicon chip. Examples of the electronic system can include a system on chip (SOC), system in package (SiP), a computer on module (COM) and the electronic device 20.

In conclusion, the present invention provides an assembly calibration process, which is able to automatically calibrate multi-cameras settings without human intervention. In detail, with automatic calibration method of the present invention, the calibration parameters for multi-camera assembly settings is obtained in accordance with the dominant motion vector, so as to avoid assembly error. In addition, this method can be applied to all multi-camera set no matter how many cameras in it or what kind camera they are.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of assembly calibration for a multi-camera system, the method comprises:
receiving at least two images respectively captured by at least two cameras in different angle of views;
performing image motion estimation on an overlapping region of the images, for obtaining correspondence between the images with a plurality of motion vectors, wherein the plurality of motion vectors are used for indicating geometry relations between the images;
performing dominant vector calculation according to the plurality of motion vectors, to obtain a dominant motion vector in region of interest (ROI) of the overlapping region; and
calculating calibration parameters according to the obtained dominant motion vector.

2. The method of claim 1, wherein the calibration parameters include de-warping, scaling, rotation and translation parameters.

3. The method of claim 1, further comprising:
performing a lens distortion correlation operation, a de-warping operation or a geometry transformation operation on the received images.

4. The method of claim 1, wherein the motion vectors include horizontal and vertical translation parameters.

5. The method of claim 4, wherein the image motion estimation includes content correspondence matching operation, optical flow operation, patch-based matching operation and feature-based matching operation.

6. An electronic device of a multi-camera system for multi-camera assembly calibration, the electronic device comprising:
an image receiving module, for receiving at least two images respectively captured by at least two cameras indifferent angle of views;
a correspondence matching module, coupled to the image receiving module, for obtaining correspondence between the images with a plurality of motion vectors, wherein the plurality of motion vectors is used for indicating geometry relations between the images in an overlapping region;
a dominant vector calculating module, coupled to the correspondence matching module, for obtaining a dominant motion vector in region of interest (ROI) of the overlapping region according to the plurality of motion vectors; and
a calibration module, coupled to the dominant vector calculating module, for calculating calibration parameters according to the obtained dominant motion vector.

7. The electronic device of claim 6, wherein the calibration parameters include de-warping, scaling, rotation and translation parameters.

8. The electronic device of claim 6, further comprising:
an image transformation module, for performing a lens distortion correlation operation, a de-warping operation or a geometry transformation operation on the received images.

9. The electronic device of claim 6, wherein the motion vectors include horizontal and vertical translation parameters.

10. The electronic device of claim 6, wherein the correspondence matching module is used for performing image motion estimation on the overlapping region of the images.

11. The electronic device of claim 10, wherein the image motion estimation includes content correspondence matching operation, optical flow operation, patch-based matching operation and feature-based matching operation.

12. A multi-camera system for assembly calibration, the multi-camera system comprising:
at least two cameras, for capturing images in different angle of views;
an electronic device, connecting to the at least two cameras, for performing an assembly calibration operation;
wherein the electronic device includes:
a processing means for executing a program; and
a storage unit coupled to the processing means for storing the program; wherein the program instructs the processing means to perform the following steps:
receiving at least two images respectively captured by the at least two cameras in different angle of views;
performing image motion estimation on an overlapping region of the images, for obtaining correspondence between two images with a plurality of motion vectors, wherein the plurality of motion vectors is used for indicating geometry relations between the images;
performing dominant vector calculation according to the plurality of motion vectors, for obtaining a dominant motion vector in region of interest (ROI) of the overlapping region; and
calculating calibration parameters according to the obtained dominant motion vector.

13. The multi-camera system of claim 12, wherein the program further instructs the processing means to perform the following steps:
performing a lens distortion correlation operation, a de-warping operation or a geometry transformation operation on the received images.
